(19) United States
(12) Patent Application Publication
(10) Pub. No.: US 2010/0085377 A1
(43) Pub. Date: Apr. 8, 2010

(54) CONSTRAINED LANGUAGE-BASED COLOR SELECTION ALGORITHM

(75) Inventor: Geoffrey J. Woolfe, Wahroonga (AU)

Correspondence Address: Ronald F. Chapuran;Patent Documentation Center, Xerox Corporation, 100 Clinton Avenue South, Xerox Square, 20th floor, Rochester, NY, 14644, US

(73) Assignee: Xerox Corporation, Norwalk, CT (US)

(21) Appl. No.: 12/247,421

(22) Filed: Oct. 8, 2008

(51) Int. Cl. G09G 5/02

(52) U.S. Cl. 345/594

(57) ABSTRACT

A method to specify a color selection that allows users to construct verbal color descriptions of desired colors for color modification or correction using various components. These components include a user interface component for creating and combining color selection descriptions using menus or other suitable display techniques, a mapping or classifier component to map menu-items to representative color-samples, a component that translates representative color-samples to a mathematical selection transform and a component that maps a set of test colors through the mathematical selection transform to implement the color selector.

The embodiments disclosed herein relate to a color editing system, and more specifically, a user-friendly color editing system.

There are many ways to specify color and color difference. Color imaging scientists and engineers use precise, numeric color specifications based on standardized color spaces and color encodings. Such color specifications are often based on the color matching behavior of a standard human observer and are implemented in device-independent color encodings as well as in device dependent color encodings.

Another form of specifying color is to use color names in natural language as described in pending application U.S. Ser. No. 11/479,484 filed by Geoffrey J. Woolfe, titled: Natural Language Color Communication and System Interface—Publication No. 20080007749, published Jan. 10, 2008 (Attorney File No. 20051444), this application being assigned to the same assignee as the present invention, and the subject matter of the specification of this application being incorporated herein. Although natural language is a far less precise method of color specification than those discussed above, it is nonetheless the most widely used and best understood method of color specification used by consumers of color.

This method of color specification uses common color names, such as red, green, blue, etc. It also uses combinations of common color names to refine the specification. Examples of such combinations include reddish-brown, greenish-blue, yellowish-green etc. In addition, natural language provides many modifying adjectives or phrases to provide further subtle discrimination in color specification. Examples of such modifying adjectives or phrases include light, dark, bright, saturated, vivid, muddy, moderate, dull, pale, washed-out or “slightly less yellow”, “much darker”, “more saturated”, “greener”, “significantly punchier”, and “a smidge lighter”. While these expressions may not be precise, many people commonly use them to describe how they would like their printed material to be changed to meet their requirements.

Color management calls for the ability to produce consistent, predictable and pleasing color across a wide range of devices, media, halftones, and document types. The requirement for “pleasing color” involves subjective judgment, and depends heavily on the market, the application, and the individual customer. Thus there is invariably a need to offer tools by which customers can edit colors in a document according to their preference and expectation. An easy and intuitive means for controlling colors using natural language constructs (NLC) has been described in the above referenced patent application. In such a system, a graphical interface allows the user to specify the desired colors via a sequence of natural language phrases such as: “Make greens much lighter”. These phrases are converted into a mathematical transform such as a 3-dimensional lookup table (LUT), which can then be applied to images, and/or stored in abstract or device International Color Consortium (ICC) profiles. A difficulty with the prior art, however, is that once the mathematical transform is calculated and stored in the profile, there is no straightforward way to retrieve the original NLC representation that produced the transform, other than to analyze the mathematical transform and estimate the language-based edits from which the transform stemmed.

The natural language method of creating a color selection has a number of advantages over existing methods such as only requiring a user to be able to provide a verbal description of the color selection. No technical color knowledge is required. Also, the method can be easily applied to all types of color data—in the form of an image or simply a collection of color data. Another major advantage is that the selection boundaries, as defined in the transform color encoding, follow perceptual color naming boundaries that reflect the way human observers mentally categorize colors. This provides a natural and well behaved selection compared to the results obtained using arbitrary geometrical boundaries around a color center.

The present invention includes various aspects and methods to allow users to specify a color selection using a set of menus or any other suitable displayed means to construct verbal color descriptions. It should be noted that in an exemplary embodiment, three menus are described, but that the scope of the invention encompasses any number of screen menus or any other display or selection technique to simplify a color selection process.

The invention technique or method includes various components or steps combined in a suitable manner to provide a desired color modification or correction. These components or steps include a user interface component that allows users to create and combine color selection descriptions using menus or other suitable display techniques, a mapping or classifier component to map menu-items to representative color-samples, a component that translates representative color-samples to a mathematical selection transforms, a component, if necessary, that can transform an arbitrary set of test color coordinates into a color encoding identical to the coding used to build the mathematical selection transforms, and a component to map the arbitrary set of test colors through the mathematical selection transform to implement the color selector to indicate whether each of the test colors is in the selection or the probability that each of the test colors is in the selection.

The present invention requires no special knowledge or understanding of the technicalities of color. It enables color-naïve users to quickly and easily make a sophisticated selection of a subset of colors within a larger set of colors. Such a set of colors could be in the form of an image, a color management profile or even a (virtual) collection of color samples or swatches. In the described embodiment, the user builds sets of simple color descriptions using two menus and then combines these color descriptions using a third list box menu and, optionally, a set of check boxes or select buttons to indicate whether the described color is to be specifically included or excluded in the eventual selection. The combined color descriptions provide a language-based specification for the color selection to be made.

These combined color descriptions provide a number of important features of the color selection including: 1) the ability to select a union of multiple color regions that are either contiguous (e.g. reds, oranges) or non-contiguous (e.g. reds and greens) regions of color; 2) the ability to eliminate or omit a sub region from a more general selection (e.g. all greens but not dark greens and reds and oranges and bright yellows but not pale reds'); and 3) the ability to use a qualifier to a more basic color name (pale greens and bright yellows).

The natural language color description is translated into a mathematical transform that makes the selection. The mathematical transform returns either a Boolean result indicating whether a color is in or outside, the selection or it returns a continuous result indicating the probability that the color is likely to be inside the selection. In the latter case the selection transform might return a value of 1 if a color is definitely in the selection and a value of 0 if the color is definitely outside the selection. A returned value of 0.5 would indicate that there is a 50% probability that a color is in the selection. The construction and operation of the selection transform is invisible to the user. In use, the selection transform would be applied to a set of colors to return only the selected colors. If the set of colors is an image then the selection would likely be returned in the form of a mask—either binary or continuous. If the set of colors is in the form of a list of colors then the selection could be returned either as a list of indices into the list or a set of probabilities representing the probability that each color in the set is in the selection. If the set of colors is a collection of color samples or swatches then the selector could return a set of descriptors (e.g. names or numerical color coordinates) of the samples or swatches that are in the selection.

A typical exemplary embodiment will be described in detail, with reference to the following figures.

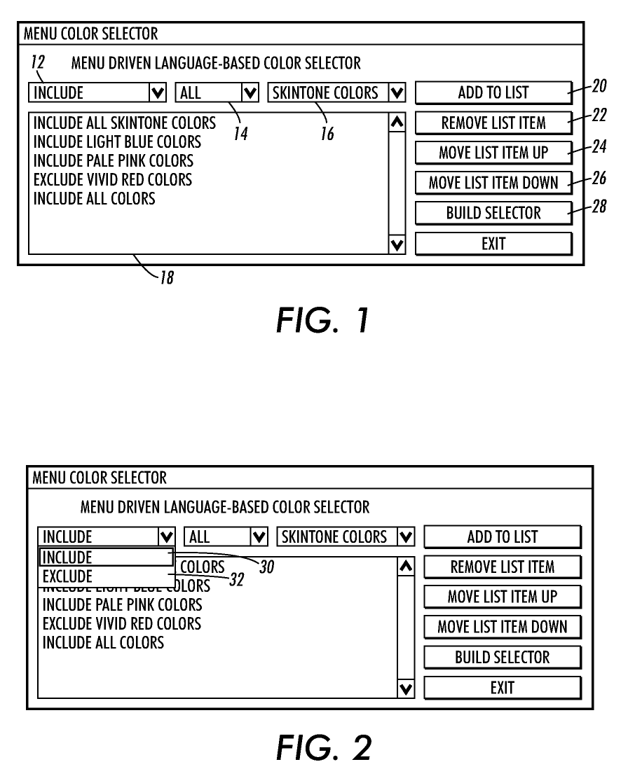

FIG. 1 illustrates an exemplary user interface screen in accordance with the present invention.

FIG. 2 is a typical popup menu with first choices in accordance with the present invention.

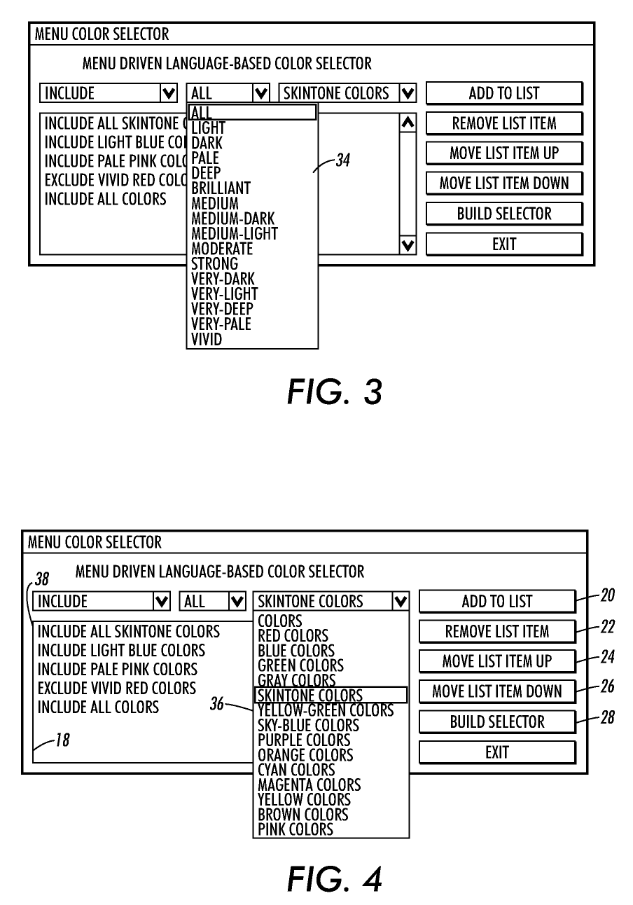

FIG. 3 is a typical popup menu with second choices in accordance with the present invention.

FIG. 4 is a typical popup menu with third choices in accordance with the present invention.

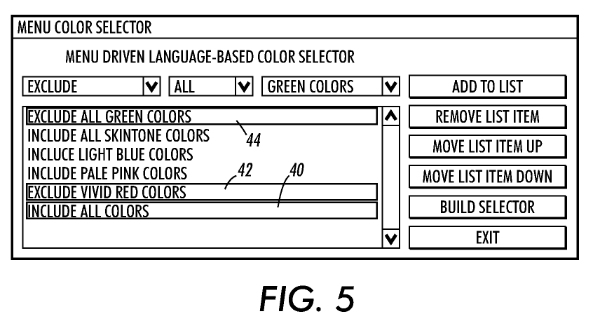

FIG. 5 illustrates multiple selections from a listbox in accordance with the present invention.

Component 1 of an exemplary embodiment of the invention is a user interface that allows users to create and combine color selection descriptions. FIG. 1 shows a typical screen display of the user interface component that provides a set of menus that allow a user to create and combine sets of language-based descriptions of colors that are to be included in the selection. In this embodiment the user interface consists of three popup menus 12, 14, and 16 that allow the creation of color descriptions to be included or excluded in the selection. Color descriptions are added to a listbox 18 and various controls are provided such as Add to List 20, Remove List Item 22, Move List Item Up 24, Move List Item Down 26 and a button Build Selector 28 to combine selected color descriptions from the listbox 18.

As shown in FIG. 1, the three popup menus 12, 14, and 16 near the top of the interface allow the user to construct phrases that describe colors and whether the colors should be included or excluded in the color selection. The first, leftmost, popup menu 12 allows the user to specify whether the color will be included or excluded from the selection. In this example it provides two choices—include 30 or exclude 32 as illustrated in FIG. 2. The reason for providing an “exclude” option is to allow the creation of complex selections such as “include all green colors, exclude pale green colors”, where the excluded region overrides the selection of all green colors. This will become apparent in the explanation of combining color descriptions below.

The second popup menu 14, in the center of the group of three menus provides a choice of color modifiers 34 illustrated in FIG. 3. These modifiers 34 allow for more precise description of broad color categories. In this example the entries in this menu include “all”, “light”, “dark”, “pale”, “deep”, “brilliant”, “medium”, “medium-dark”, “medium-light”, “moderate”, “strong”, “very-dark”, “very-light”, “very-deep”, “very-pale” and “vivid”.

The third popup menu 16, on the right of the group of three menus provides a choice of basic useful color names 36 as shown in FIG. 4. These should generally include at least the basic 11 or 12 fundamental color names as well as the names of important memory colors such as sky and skin. In this example the entries in this menu include “colors”, “red colors”, “blue colors”, “green colors”, “gray colors”, “skintone colors”, “yellow-green colors”, “sky-blue colors”, “purple colors”, “orange colors”, “cyan colors”, “magenta colors”, “yellow colors”, “brown colors” and “pink colors”.

In this embodiment, the three popup menus are used to create color descriptions that can be used to create a color selection. With reference to FIG. 4 the illustration shows the color description “include all skintone colors” 38 being created. Once a color description has been created it can be added to the listbox by pressing the Add to List button 20. The color description then appears in the listbox 18. It can be seen from FIG. 4 that many color descriptions can be created and added to the listbox.

The Remove List Item 22, Move List Item Up 24 and Move List Item Down 26 are provided to manipulate the color descriptions in the listbox. Having populated the listbox with a number of appropriate color descriptions, the user interface now allows the user to define a complex language-based color specification description by selecting one or more of the color descriptions in the listbox. In the example shown in FIG. 5, the user has chosen three of the color descriptions from the listbox:

1. include all colors 40

2. exclude vivid red colors 42

3. exclude all green colors 44

These choices together define a color selection specification that will select all colors except green colors and vivid red colors.

For any color description that is added to the listbox, in addition to the language-based description, a numeric code is also stored. In this embodiment that code is simply a vector of 3 integers—the integers corresponding to the selections made in each of the three popup menus. Other methods of numerically encoding the menu selections could be used but this embodiment describes one of the simplest. The numerical codes for the menus in this embodiment are shown in Tables 1, 2 and 3.

TABLE 1
Numerical codes for first popup menu.

| Menu Item | Numerical Code |
|---|---|
| Include | 1 |
| Exclude | 2 |

TABLE 2
Numerical Codes for second popup menu.

| Menu Item | Numerical Code |
|---|---|
| All | 1 |
| Light | 2 |
| Dark | 3 |
| Pale | 4 |
| Deep | 5 |
| Brilliant | 6 |
| Medium | 7 |
| Medium-dark | 8 |
| Medium-light | 9 |
| Moderate | 10 |
| Strong | 11 |
| Very-dark | 12 |
| Very-light | 13 |
| Very-deep | 14 |
| Very-pale | 15 |
| Vivid | 16 |

TABLE 3
Numerical Codes for third popup menu.

| Menu Item | Numerical Code |
|---|---|
| Colors | 1 |
| Red colors | 2 |
| Blue colors | 3 |
| Green colors | 4 |
| Gray colors | 5 |
| Skintone colors | 6 |
| Yellow-green colors | 7 |
| Sky-blue | 8 |
| Purple | 9 |
| Orange | 10 |
| Cyan colors | 11 |
| Magenta colors | 12 |
| Yellow colors | 13 |
| Brown colors | 14 |
| Pink colors | 15 |

The numerical codes play a vital role in component 2. In fact when a user presses the button labeled Build Selector 28, these codes are passed on to component 2 in the form of an array. In the example shown in FIG. 5, the following array of numerical codes would be passed:

$$[ \begin{matrix}2 & 1 & 4 \\ 2 & 16 & 2 \\ 1 & 1 & 1\end{matrix} ]$$

The first row of this array corresponds to the verbal description “exclude all green colors”, the second row to “exclude vivid red colors”, and the third to “include all colors”.

Component 2 of an exemplary embodiment of the invention is a mapping or classifier component to map color descriptions to representative color-samples. This component takes the array of numerical codes from Component 1 and uses them to select colors from a collection of color samples. The collection of color samples is a sampling of colors that can exist in a given color encoding. The exact colors used in the collection are not critically important, it is simply necessary that the collection fully samples the range of visible colors and that there are multiple samples for each of the colors that can be described using the menus of Component 1. A useful collection of colors is the set of NBS-ISCC standard named colors. In the embodiment described here, this set is augmented by a uniform sampling of colors from the gamut surface of the sRGB color encoding. The collection of color samples is represented simply as a set of color coordinates in an appropriate color encoding. Color names for the samples are not required.

Each of the fundamental color names listed in popup menu 16, has a set of corresponding samples from the collection associated with it. The association is made using indices that point to the locations of the samples in the collection. This association can be performed using psychophysical techniques in which a panel of observers is shown the full collection of color samples and then asked to select from the collection all those samples that could be described as, for example, “red colors”. The test is then repeated for each of the color description listed in popup menu 16. This is a very easy procedure to undertake and observers have almost no difficulty undertaking the task. After appropriate data analysis, each color description listed in popup menu 16 will have a set of samples from the collection of color samples.

Upon receiving the array of numerical codes from Component 1, Component 2 builds two lists of indices into the collection of color samples—a list of the indices corresponding to the colors that are to be included in the selection, (IdxStdInc), and a second list of indices corresponding to the colors that are to be specifically excluded from the selection, (IdxStdExc).

A method by which these two lists are constructed is described in the attached Appendix. It should be understood that this description is of one embodiment of the invention other methods can be used to build these lists.

Component 3 is a transform building component that takes the two lists of indices into the collection of color samples from Component 2 and uses them to create a mathematical transform to perform the color selection operation on any set of arbitrary input colors. Note that the mathematical transform is generally designed to work on color data that is encoded using the same system used to encode the color coordinates of collection of sample colors. Typically these will be encoded in a reasonably perceptually uniform color space such as CIELab or CIELuv. The color encoding used is referred to henceforth as the “transform color encoding”. The function of the mathematical transform is to determine whether any arbitrary input colors is sufficiently close to one of the sample colors included in the selection (i.e. those having indices which appear in the list IdxStdInc but do not appear in the list IdxStdExc).

In one embodiment, the Component 3 builds a multi-dimensional lookup table using the following steps:
a. Create a set of samples representing all colors that can be defined in the transform color encoding. If the transform color encoding has D dimensions then the samples will be defined on a D-dimensional grid. It is not necessary that the samples have uniform spacing, although it can be advantageous. For example, if the transform color encoding is CIELab, then D=3 corresponding to dimensions of L*, a* and b*.
b. Use the indices and color coordinates (in the transform color encoding) of the sample color collection to construct a kd-tree. In computer science, a kd-tree (short for k-dimensional tree) is a space-partitioning data structure for organizing points in a k-dimensional space. kd-trees are a useful data structure for several applications, such as searches involving a multidimensional search key (e.g. range searches and nearest neighbor searches).
c. Map each point in the sample grid created in step a, through the kd-tree created in step b to determine the closest standard color to each sample grid color.
d. Create a mapping grid of D-dimensions containing exactly the same number of grid points as were created in the sample color grid created in step a. The mapping grid point is set to 1 if the corresponding sample color has a nearest neighbor standard color that has an index in the list IdxStdInc. Otherwise, or if the nearest neighbor standard color has an index in the list IdxStdExc, set the mapping grid point to 0. The mapping grid is now a D-dimensional grid with grid points relating to each of the sample colors created in step a, but with a value equal to 1 if the sample color is in the color selection and 0 if the outside the color selection.
e. Optionally, in the interest of creating a well-behaved, smooth selection transform, the mapping grid created in step d can be smoothed (i.e. sharp edges softened) by convolving it with a D-dimensional Gaussian (or similar) blurring filter.
   At the end of these steps a mapping grid has been created. The mapping grid acts as a color selector when it is used as a multi-dimensional lookup table in Component 5.

Component 4 is a color transforming component. In order to use the color selector created in Component 3 with any arbitrary set of test colors, it is necessary that the test colors be encoded in the transform color encoding. Accordingly Component 4 provides a mechanism to convert color coordinates in any arbitrary color encoding to the transform color encoding. This is a standard color management operation and can be accomplished using ICC color management profiles and a standard color management engine.

Component 5 is a component to apply the color selection transform to test colors. This component takes the set of test color coordinates, encoded in the transform color encoding, created in Component 4 and maps them through the mathematical selection transform created in Component 3. In one embodiment, the mathematical selection transform is a multi-dimensional lookup table and this component performs interpolation of the mathematical selection transform to obtain an output value for each of the test color coordinates. Typical interpolation methods are well know by those skilled in the art and could include multi-linear interpolation (trilinear interpolation for a 3 dimensional LUT) or interpolation using D-dimensional simplices having D+1 faces (tetrahedral interpolation for a 3 dimensional LUT). In the embodiment described in this disclosure, the interpolation returns values between 0 and 1 for each of the test colors. This value can be interpreted as the probability that the test color is in the selection.

Although the present invention has been described with reference to particular embodiments, it should be recognized that these embodiments are merely illustrative of the principles of the present invention and that the scope of the present invention is broadly applicable as defined in the attached claims.

What is claimed is:

1. In a system having a user interface with representative color: samples and a display screen, a method of editing color images comprising the steps of:
providing color selection descriptions using display screen menus,
mapping the color selection descriptions to the representative color-samples, and
translating the representative color-samples to selection transforms.

2. The method of claim 1 wherein the selection transforms comprise a given color encoding and including the step of transforming the representative color samples into the given color encoding of the selection transforms.

3. The method of claim 1 including the step of defining the representative color samples within the color selection descriptions.

4. The method of claim 1 including the step of defining the probability of the representative color samples being within the color selection descriptions.

5. The method of claim 1 wherein the step of providing color selection descriptions using display screen menus includes the step of constructing verbal color selection descriptions.

6. The method of claim 5 including the step of combining verbal color selection descriptions.

7. The method of claim 5 including the option of excluding a given color from the verbal selection descriptions.

8. The method of claim 5 including the step of providing a choice of color modifiers.

9. The method of claim 5 including the step of providing a choice of color names.

10. In a color imaging system, a method of color selection for color images including the steps of:
providing a user interface with screen for displaying information related to color images,
displaying a set of operations for providing color selection descriptions,
mapping the color selection descriptions to a set of representative color samples, and
translating the representative color samples to a mathematical selection transform.

11. The method of claim 10 wherein the step of displaying a set of operations for providing color selection descriptions includes the step of combining selected verbal color descriptions.

12. The method of claim 11 wherein the step of combining selected verbal color descriptions includes the step of selecting verbal color descriptions from the screen.

13. The method of claim 12 wherein the step of selecting verbal color descriptions from the screen includes the step of selecting verbal color descriptions from a set of menus on the screen.

14. The method of claim 12 wherein the step of selecting verbal color descriptions from the screen includes the step of providing a choice of color modifiers and a choice of color names.

15. The method of claim 10 wherein the mathematical selection transforms comprise a given color encoding and including the step of transforming the set of representative color samples into the given color encoding of the mathematical selection transforms.

16. In a color imaging system having a user interface with a screen for describing color corrections in verbal descriptions, a method of providing color correction for color images including the steps of:
providing a choice of verbal color modifiers on the screen for the color correction, and
providing a choice of verbal color names on the screen for the color correction.

17. The method of claim 16 including the step of selectively choosing verbal color modifiers and verbal color names for a given color correction.

18. The method of claim 17 including the step of selectively choosing verbal color modifiers and verbal color names from a set of menus on the screen.

19. In a system having a memory and a user interface with a display screen, a method of editing color images comprising the steps of:
providing color descriptions on the display screen of the user interface for selection,
selecting a set of color descriptions,
mapping the set of color descriptions to a set of color samples, the set of color samples being stored in memory, and
translating the representative color samples to a set of mathematical transforms.

20. The method of claim 19 wherein the mathematical transforms comprise a transform color encoding and including the step of converting the set of color samples into the transform color encoding.

21. The method of claim 20 wherein the set of color samples include arbitrary colors with color coordinates and including the step of converting the color coordinates of the arbitrary colors into the transform color encoding.

22. The method of claim 19 wherein the step of mapping the set of color descriptions to a set of color samples includes the step of defining the probability that each of the set of color samples is within the color descriptions.
